(19) United States
(12) Patent Application Publication
(10) Pub. No.: US 2022/0294082 A1
(43) Pub. Date: Sep. 15, 2022

(54) Electrode Assembly and Method for Manufacturing the Same

(71) Applicant: LG Energy Solution, Ltd., Seoul (KR)

(72) Inventor: Su Han Park, Daejeon (KR)

(73) Assignee: LG Energy Solution, Ltd., Seoul (KR)

(21) Appl. No.: 17/724,055

(22) Filed: Apr. 19, 2022

(30) Foreign Application Priority Data
Mar. 10, 2021 (KR) 10-2021-0031681

(51) Int. Cl. H01M 50/46; H01M 10/42; H01M 10/0585

(52) U.S. Cl. CPC H01M 50/46; H01M 10/4235; H01M 10/0585

(57) ABSTRACT

An electrode assembly includes a separator, which is doubly sealed in a radical unit and a unit stack part to prevent short circuit occurring by contact between a positive electrode and a negative electrode due to contraction of the separator. The electrode assembly includes a unit stack part having a stacked structure including a plurality of radical units and an outer sealing part formed outside the unit stack part. Each of the radical unit is formed by alternately stacking electrodes and separators and includes a first inner sealing part in which a plurality of separators vertically stacked on the electrodes are sealed to each other on a side surface of each of the electrodes, and the outer sealing part is formed by sealing the separators of the plurality of radical units to each other outside the first inner sealing part.

### CROSS-REFERENCE TO RELATED APPLICATIONS

This application claims the priority of Korean Patent Application 10-2021-0031681, filed on Mar. 10, 2021, in the Korean Intellectual Property Office, the disclosure of which is incorporated herein by reference.

### BACKGROUND OF THE INVENTION

### Field of the Invention

The present invention relates to an electrode assembly and a method for manufacturing the same, and more particularly, to an electrode assembly in which a separator is doubly sealed in a radical unit and a unit stack part to prevent short circuit occurring by contact between a positive electrode and a negative electrode due to contraction of the separator and improve safety of the battery, and a method for manufacturing the same.

### Description of the Related Art

A secondary battery is a chargeable and dischargeable battery unlike a primary battery that is not chargeable. The secondary battery is widely used not only in small electronic devices such as mobile phones and laptops, but also in large products requiring high output such as electric vehicles, power storage devices that store surplus power or renewable energy, and power storage system (ESS) for backup.

The secondary battery has a structure in which an electrode assembly and an electrolyte are embedded in a case such as a can or a pouch. The electrode assembly has a structure in which a positive electrode, a separator, and a negative electrode are repeatedly stacked. Representatively, the electrode assembly may be classified into a jelly-roll type (winding type) electrode assembly that is manufactured by winding long sheet-shaped positive electrodes and negative electrodes with a separator therebetween, a stacked type electrode assembly that is manufactured by sequentially stacking a plurality of positive electrodes and negative electrodes, which are cut into units each of which has a predetermined size, with a separator therebetween, and a stack and folding type electrode assembly.

A lamination & stacking method has recently been developed as a new method for manufacturing an electrode assembly to increase in energy density and reduce a process time in the same space.

Referring to the manufacturing process according to the lamination and stacking method, cut electrodes are disposed at predetermined intervals on upper portions of one or more separators that are continuously supplied. Thereafter, in a heating process, the electrodes and the separator, which are combined to improve bonding force between the separator and the electrodes. In a bonding process, an electrode stack, in which the separator and the electrodes are stacked (in a state in which unit cells or radical units are formed to be spaced a predetermined interval from each other) passes through a pair of rollers so as to be rolled so that the electrodes and the separator are bonded to each other by heat and a pressure. Thereafter, the stacked electrodes and separator are cut into unit cells or radical units, and the cut unit cells or radical units are transferred and stacked to form an electrode assembly.

The secondary battery is becoming more and more high-capacity and high-voltage, and in particular, a high nickel (Ni>60%)-based positive electrode active material is used as a positive electrode material. Here, the higher the nickel content, the higher a heat generation amount and the lower a structural collapse temperature, and thus there is a limitation in that thermal stability of the battery is deteriorated. Particularly, when manufacturing the electrode assembly in the lamination and stacking method according to the related art, the electrode assembly has a structure, in which the separator is separated from a side surface thereof, and thus, there is a limitation in that it is more disadvantageous to thermal contraction. When the separator is thermally contracted as described above, the positive electrode and the negative electrode, which are in the state of being separated from each other, are in contact with each other to cause short circuit and also deteriorate performance of the battery and leading to ignition and explosion of the battery, thereby greatly threating safety of the user.

Therefore, to solve the above limitation, according to the related art, the separator having a sufficient size in consideration of an amount of thermal contraction of the separator, but there is another limitation of increasing in manufacturing cost.

In addition, as illustrated in FIG. 1, in the related art, an electrode assembly 10 in which the separator 13 is single-sealed on a side surface of each of electrodes 11 and 12 has been developed. However, in the form illustrated in FIG. 1, after the plurality of electrodes 11 and 12 and the separator 13 are stacked, since the separator 13 exposed to the side surfaces of the electrodes 11 and 12 is sealed at once, a case in which the sealing of the bonded and sealed portion is easily released frequently occurs. As described above, in the case in which the single sealing is released, there is still a risk of short circuit due to thermal contraction of the separator, and thus, there is a limitation in that safety of the battery is not sufficiently secured. Accordingly, there is a need for an electrode assembly capable of solving the above limitations and a method for manufacturing the same.

### SUMMARY OF THE INVENTION

An aspect of the present invention provides an electrode assembly in which a separator is doubly sealed in a radical unit and a unit stack part to prevent short circuit occurring by contact between a positive electrode and a negative electrode due to contraction of the separator and improve safety of the battery, and a method for manufacturing the same.

According to an aspect of the present invention, there is provided an electrode assembly including: a unit stack part having a stacked structure including a plurality of radical units; and an outer sealing part formed outside the unit stack part, wherein each of the radical unit is formed by alternately stacking electrodes and separators and comprises a first inner sealing part in which a plurality of separators vertically stacked on the electrodes are sealed to each other on a side surface of each of the electrodes, and the outer sealing part is formed by sealing the separators of the plurality of radical units to each other outside the first inner sealing part.

The first inner sealing part may be sealed so that the separator remains outside the first inner sealing part, and the outer sealing part may be formed by sealing the separator remaining outside the first inner sealing part.

The radical unit may be a mono-cell in which a separator, a first electrode, a separator, and a second electrode are stacked.

The first inner sealing part may be formed by sealing the separators vertically stacked on the first electrode to each other on a side surface of the first electrode.

The unit stack part may further include an auxiliary unit stacked at the uppermost end of the plurality of radical units, and the auxiliary unit may be a half-cell in which a separator, a third electrode, and a separator are stacked.

The auxiliary unit may include a second inner sealing part formed by sealing the separators vertically stacked on the third electrode to each other on a side surface of the third electrode.

The second inner sealing part may be sealed so that the separator remains outside the second inner sealing part, and the outer sealing part may be formed by sealing the separators remaining outside the first inner sealing part of the radical unit and the second inner sealing part of the auxiliary unit together.

The radical unit may be a C-type bi-cell, in which a separator, a first electrode, a separator, a second electrode, a separator, and a first electrode are stacked, or an A-type bi-cell, in which a separator, a second electrode, a separator, a first electrode, a separator, and a second electrode are stacked, and the unit stack part may be formed by alternately stacking the C-type bi-cell and the A-type bi-cell.

According to another aspect of the present invention, there is provided a method for manufacturing an electrode assembly, the method including: alternately stacking electrodes and separators to manufacture a radical unit; stacking a plurality of radical units to form a unit stack part; and forming an outer sealing part outside the unit stack part, wherein, in the manufacturing of the radical unit, after the electrodes and the separators are alternately stacked, the plurality of separators vertically stacked on the electrodes are sealed to each other on a side surface of each of the electrodes to forma first inner sealing part, and in the forming of the outer sealing part, the separators of the plurality of radical units are sealed to each other outside the first inner sealing part to form an outer sealing part.

in the manufacturing of the radical unit, the first inner sealing part may be formed so that the separator remains outside the first inner sealing part, and in the forming of the outer sealing part, the separator remaining outside the first inner sealing part may be sealed to an outer sealing part.

In the forming of the unit stack part, the radical units may be stacked, wherein an auxiliary unit may be stacked at an uppermost portion.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of an electrode assembly according to a related art;

FIG. 2 is a cross-sectional view of an electrode assembly according to Embodiment 1 of the present invention;

FIG. 3 is a cross-sectional view illustrating a radical unit of the electrode assembly according to Embodiment of the present invention;

FIG. 4 is a cross-sectional view illustrating an auxiliary unit of the electrode assembly according to Embodiment of the present invention;

FIG. 5 is a cross-sectional view of an electrode assembly according to Embodiment 2 of the present invention; and

FIG. 6 is a cross-sectional view illustrating a radical unit of the electrode assembly according to Embodiment 2 of the present invention.

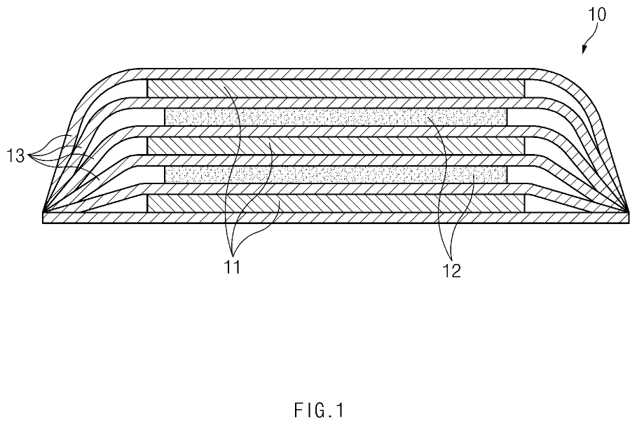

### DETAILED DESCRIPTION

Hereinafter, preferred embodiments of the present invention will be described in detail with reference to the accompanying drawings so that those of ordinary skill in the art can easily carry out the present invention. However, the present invention may be implemented in several different forms and is not limited or restricted by the following examples.

In order to clearly explain the present invention, detailed descriptions of portions that are irrelevant to the description or related known technologies that may unnecessarily obscure the gist of the present invention have been omitted, and in the present specification, reference symbols are added to components in each drawing. In this case, the same or similar reference numerals are assigned to the same or similar elements throughout the specification.

Also, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

### Embodiment 1

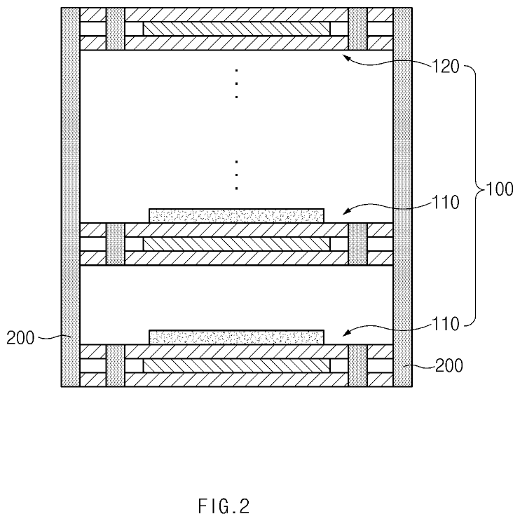

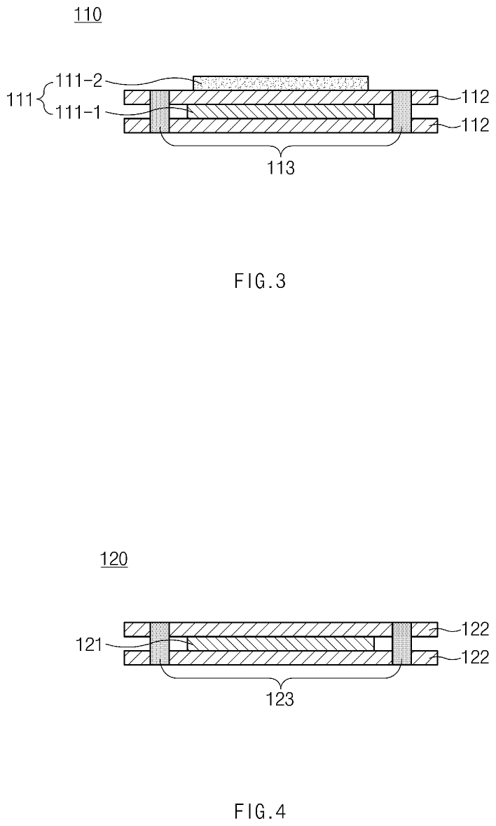

FIG. 2 is a cross-sectional view of an electrode assembly according to Embodiment 1 of the present invention. FIG. 3 is a cross-sectional view illustrating a radical unit of the electrode assembly according to Embodiment of the present invention; FIG. 3 is a cross-sectional view illustrating an auxiliary unit of the electrode assembly according to Embodiment of the present invention.

Referring to FIG. 2, an electrode assembly according to Embodiment 1 of the present invention includes a unit stack part 100 and an outer sealing part 200. In addition, the electrode assembly may further include an electrode tab (not shown) and an electrode lead (not shown).

Hereinafter, detailed configurations of the unit stack part 100 and the outer sealing part 200 will be described with reference to FIGS. 2 to 4.

First, as illustrated in FIG. 2, the unit stack part 100 includes a plurality of radical units 110 and is formed by vertically stacking the plurality of radical units 110. As illustrated in FIG. 3, the radical unit 110 is formed by alternately stacking electrodes 111 and a separators 112 and may include various types of radical units 110, for example, a mono-cell in which a separator 112, a first electrode 111-1, a separator 112, and a second electrode 111-2 are stacked. Here, the first electrode 111-1 may be a negative electrode, and the second electrode 111-2 may be a positive electrode. On the contrary, the first electrode 111-1 may be formed as a positive electrode, and the second electrode 111-2 may be formed as a negative electrode. As described above, when the radical unit 110 is formed as the mono-cell, a single type of the radical unit 110 may be continuously stacked to improve productivity and reduce manufacturing and facility costs.

Referring to FIG. 3, in the radical unit 110 according to Embodiment 1 of the present invention, a first inner sealing part 113 in which the plurality of separators 112 vertically stacked on the electrodes 111 are sealed to each other on the side surfaces of the electrodes. In general, the separator 112 is disposed between the positive electrode and the negative electrode so that each of the electrodes 111 is not in contact with each other. When the separator 112 is damaged or contracted by heat, the positive electrode and the negative electrode are in contact with each other to resulting in the short circuit. Therefore, the radical unit 110 of the present invention may include the first inner sealing part 113 to prevent the short circuit of the electrode 111 that may occur due to the contraction of the separator 112 from each unit of the radical units 110, thereby more improving safety of the battery.

Here, the side surface of the electrode 111, on which the first inner sealing part 113 is formed, may mean two side surface facing each other without forming the electrode tab thereon in the electrode 111 having a rectangular shape. That is, in the radical unit 110 according to Embodiment 1 of the present invention, the separator 112 is sealed on only two side surfaces of the electrode 111, not on four side surfaces of the electrode to form the first inner sealing part 113, thereby realizing superior electrolyte wetting compared to the electrode assembly, in which all the four surfaces are sealed.

Referring to FIGS. 2 and 3, the outer sealing part 200 of the electrode assembly according to Embodiment 1 of the present invention is formed outside the unit stack part 100. In detail, the separator 112 of the plurality of radical units 110 are sealed outward to each other in the first inner sealing part 113. As described above, in the electrode assembly according to Embodiment 1 of the present invention, the short circuit of the electrode 111 due to the contract of the separator 112 in each unit of the radical unit 110 and the unit stack part 100 may be doubly prevented through the dual sealing structure of the first inner sealing part 113 and the outer sealing part 200 to more improve the safety of the battery compared to the electrode assembly having the open separator structure or the single sealed structure.

According to the structures and the sealing methods of the first inner sealing part 113 and the outer sealing part 200, as illustrated in FIG. 3, the first inner sealing part 113 may be sealed so that the separator 112 remains outside the first inner sealing part 113, and as illustrated in FIG. 2, the outer sealing part may be formed to be sealed so that the separator 112 remains outside the first inner sealing part 113 remains outside the first inner sealing part 113. Here, when the radical unit 110 is formed as the mono-cell, the first inner sealing part 113 may be formed so that the separators 112 vertically stacked on the first electrode 111-1 are sealed to each other on a side surface of the first electrode 111-1, and the outer sealing part 200 may be sealed by bonding all the separators 112 remaining outside the first inner sealing part 113 in the plurality of stacked mono-cells. As described above, in the electrode assembly according to Embodiment 1 of the present invention, the sealing is performed at each unit of the radical units 110 to form the first inner sealing part 113, and then, the separator 112 remaining outside the first inner sealing part 113 is sealed once more to form the outer sealing part 200. Thus, the safety of the battery may be improved without requiring additional equipment and without being significantly changed in structure and manufacturing process of the electrode assembly to improve efficiency and economic feasibility of the manufacturing process.

Referring to FIGS. 2 and 4, the unit stack part 100 according to Embodiment 1 of the present invention may further include an auxiliary unit 120.

The auxiliary unit 120 may be stacked at the uppermost end of the plurality of radical units 110 and may be a half-cell, in which a separator 122, a third electrode, and a separator 122 are stacked as illustrated in FIG. 4. Here, the third electrode may be formed as either the negative electrode or the positive electrode and be preferably formed at the same electrode as the first electrode 111-1 stacked on the radical unit 110.

The auxiliary unit 120 may include a second inner sealing part 123 formed by sealing the separators are sealed to each other on a side surface of the third electrode 121. The auxiliary unit 120 may be stacked on an upper portion of the radical unit 110 and include a second inner sealing part 123 corresponding to the first inner sealing part 113 of the radical unit to prevent short circuit due to contact between the electrode 111 of the radical unit 110 and the electrode of the auxiliary unit 120 from occurring.

In the second inner sealing part 123, as illustrated in FIG. 4, the separator 122 is sealed to remain outside the second inner sealing part 123, and as illustrated in FIG. 2, the outer sealing part 200 may be formed by sealing the first inner sealing part 113 of the radical unit 110 and the second inner sealing part 123 of the auxiliary unit 120 together. Thus, even if the auxiliary unit 120 may be further provided at the uppermost portion of the unit stack part 100 including the plurality of radical units 110, the dual sealing structure may be consistently formed throughout the electrode assembly, and the above-described battery may be improved in safety and efficiency of the manufacturing process.

### Embodiment 2

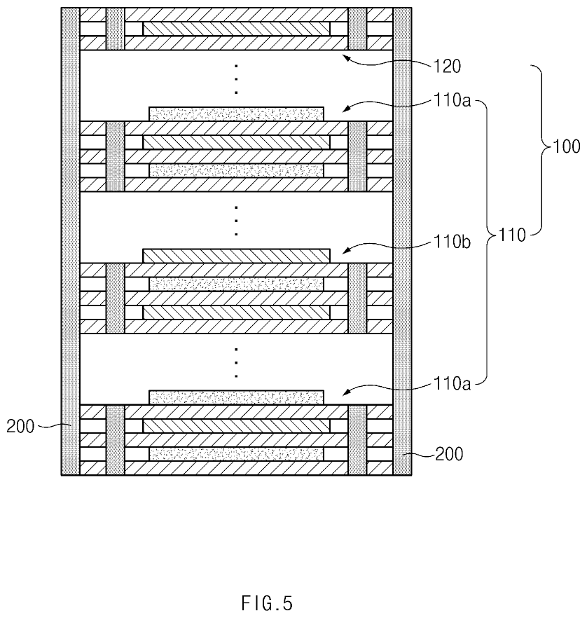

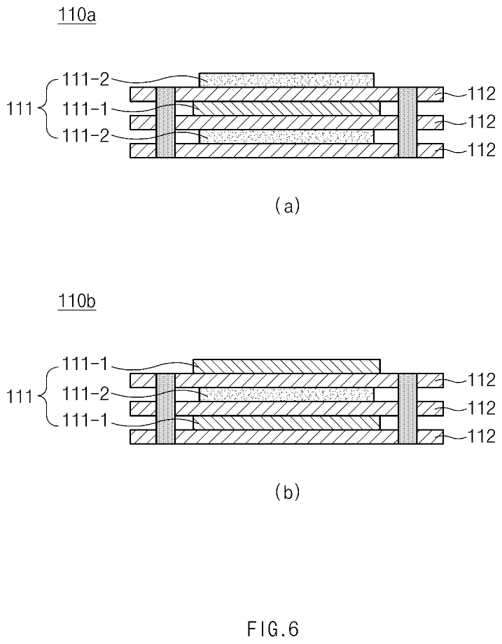

FIG. 5 is a cross-sectional view of an electrode assembly according to Embodiment 2 of the present invention. FIG. 6 is a cross-sectional view illustrating a radical unit of the electrode assembly according to Embodiment 2 of the present invention.

Embodiment 2 of the present invention is different from Embodiment 1 in that a radical unit is provided as bi-cells 110a and 110b, and a unit stack part 100 is formed by alternately stacking two types of bi-cells 110a and 110b. The contents that are duplicated with Embodiment 1 will be omitted as much as possible, and Embodiment 2 will be described with a focus on the differences. That is, it is obvious that the contents that are not described in Embodiment 2 may be regarded as the contents of Embodiment 1 if necessary.

Referring to FIGS. 5 and 6, a radical unit of an electrode assembly according to Embodiment 2 of the present invention may be a C-type bi-cell 110b, in which a separator 112, a first electrode 111-1, a separator 112, a second electrode 111-2, a separator 112, and a first electrode 111-1 are stacked, or an A-type bi-cell 110a, in which a separator 112, a second electrode 111-2, a separator, a first electrode 111-1, a separator 112, and a second electrode 111-2 are stacked. Here, the first electrode 111-1 may be a negative electrode, and the second electrode 111-2 may be a positive electrode. In addition, a unit stack part 100 may be formed by alternately stacking the C-type bi-cell 110b and the A-type bi-cell 110a. As described above, when the bi-cells 110a and 110b are stacked as a radical unit, a designed battery capacity may be obtained only by stacking a small number of radical units to increase in manufacturing speed of the unit stack part 100.

### Embodiment 3

Embodiment 3 of the present invention is different from Embodiments 1 and 2 in that it is a method for manufacturing the electrode assemblies according to Embodiments 1 and 2. The contents that are duplicated with Embodiments 1 and 2 will be omitted as much as possible, and Embodiment 3 will be described with a focus on the differences. That is, it is obvious that the contents that are not described in Embodiment 3 may be regarded as the contents of Embodiments 1 and 2 if necessary.

A method for manufacturing an electrode assembly according to Embodiment 3 of the present invention includes a process of manufacturing a radical unit 110, a process of forming a unit stack part 100, and a process of forming an outer sealing part 200.

In the process of manufacturing the radical unit 110, after an electrode 111 and a separator 112 are alternately stacked, a plurality of separators 112 vertically stacked on the electrode 111 are sealed to each other on a side surface of the electrode 111 to form a first inner sealing part 113. As described above in Embodiment 1 or 2, the radical unit 110 may be formed as a mono-cell or bi-cell, and a detailed structure thereof may be understood as being the same as in Embodiments 1 and 2.

Next, in the process of forming the unit stack part 100, a plurality of radical units 110 are stacked to form the unit stack part 100. In addition, the unit stack part 100 may be formed by stacking the plurality of radical units 110 and also stacking an auxiliary unit 120 at the uppermost portion.

In the forming of the outer sealing part 200, the separators 112 of the plurality of radical units 110 may be sealed to each other outside the first inner sealing part 113 to form an outer sealing part 200. As a result, in the method for manufacturing the electrode assembly according to Embodiment 3, a dual sealing structure may be formed, and thus, a short-circuit phenomenon of the electrode 111 due to contraction of the separator 112 may be doubly prevented to more improve safety of the battery.

In addition, in the process of manufacturing the radical unit 110, the first inner sealing part 113 may be formed so that the separator 112 remains outside the first inner sealing part 113, and in the process of forming the outer sealing part 200, the separator 112 remaining outside the first inner sealing part 113 may be sealed to form the outer sealing part 200. Therefore, only the relatively simple sealing process may be additionally performed without being changed in structure and manufacturing process of the electrode assembly to manufacture the electrode assembly having the improved safety of the battery.

The electrode assembly according to the present invention may include the unit stack part having the stacked structure including the plurality of radical units and the outer sealing part formed outside the unit stack part. The radical unit may be formed by alternately stacking the electrodes and the separator and include the first inner sealing part on which the plurality of separators vertically stacked on the electrodes are sealed on the surfaces of the electrodes, and the outer sealing part may be formed by sealing the separators of the plurality of radical units are sealed to each other outside the first inner sealing part. Therefore, the separator may be doubly sealed on the radial unit and the unit stack part, and the short circuit occurring by the contact between the positive electrode and the negative electrode due to the contraction of the separator may be prevented to improve the safety of the battery.

While the embodiments of the present invention have been described with reference to the specific embodiments, it will be apparent to those skilled in the art that various changes and modifications may be made without departing from the spirit and scope of the invention as defined in the following claims.

What is claimed is:

1. An electrode assembly comprising:
a unit stack part having a stacked structure comprising a plurality of radical units; and
an outer sealing part formed outside the unit stack part,
wherein each of the radical unit is formed by alternately stacking electrodes and separators and comprises a first inner sealing part in which a plurality of separators vertically stacked on the electrodes are sealed to each other on a side surface of each of the electrodes, and
the outer sealing part is formed by sealing the separators of the plurality of radical units to each other outside the first inner sealing part.

2. The electrode assembly of claim 1, wherein the first inner sealing part is sealed so that the separator remains outside the first inner sealing part, and
the outer sealing part is formed by sealing the separator remaining outside the first inner sealing part.

3. The electrode assembly of claim 1, wherein the radical unit is a mono-cell in which a separator, a first electrode, a separator, and a second electrode are stacked.

4. The electrode assembly of claim 3, wherein the first inner sealing part is formed by sealing the separators vertically stacked on the first electrode to each other on a side surface of the first electrode.

5. The electrode assembly of claim 1, wherein the unit stack part further comprises an auxiliary unit stacked at the uppermost end of the plurality of radical units, and
the auxiliary unit is a half-cell in which a separator, a third electrode, and a separator are stacked.

6. The electrode assembly of claim 5, wherein the auxiliary unit comprises a second inner sealing part formed by sealing the separators vertically stacked on the third electrode to each other on a side surface of the third electrode.

7. The electrode assembly of claim 6, wherein the second inner sealing part is sealed so that the separator remains outside the second inner sealing part, and
the outer sealing part is formed by sealing the separators remaining outside the first inner sealing part of the radical unit and the second inner sealing part of the auxiliary unit together.

8. The electrode assembly of claim 1, wherein the radical unit is a C-type bi-cell, in which a separator, a first electrode, a separator, a second electrode, a separator, and a first electrode are stacked, or an A-type bi-cell, in which a separator, a second electrode, a separator, a first electrode, a separator, and a second electrode are stacked, and
the unit stack part is formed by alternately stacking the C-type bi-cell and the A-type bi-cell.

9. A method for manufacturing an electrode assembly, the method comprising:
alternately stacking electrodes and separators to manufacture a radical unit;
stacking a plurality of radical units to form a unit stack part; and
forming an outer sealing part outside the unit stack part,
wherein, in the manufacturing of the radical unit, after the electrodes and the separators are alternately stacked, the plurality of separators vertically stacked on the electrodes are sealed to each other on a side surface of each of the electrodes to form a first inner sealing part, and
in the forming of the outer sealing part, the separators of the plurality of radical units are sealed to each other outside the first inner sealing part to form an outer sealing part.

10. The method of claim 9, wherein, in the manufacturing of the radical unit, the first inner sealing part is formed so that the separator remains outside the first inner sealing part, and
in the forming of the outer sealing part, the separator remaining outside the first inner sealing part is sealed to an outer sealing part.

11. The method of claim 9, wherein, in the forming of the unit stack part, the radical units are stacked, wherein an auxiliary unit is stacked at an uppermost portion.
